(19) United States
(12) Patent Application Publication
(10) Pub. No.: US 2025/0242672 A1
(43) Pub. Date: Jul. 31, 2025

(54) ROOF SYSTEM

(71) Applicant: INALFA ROOF SYSTEMS GROUP B.V., Oostrum (NL)

(72) Inventors: Marcel Johan Christiaan Nellen, Merselo (NL); Ruud Geurts, Helden (NL)

(21) Appl. No.: 19/035,090

(22) Filed: Jan. 23, 2025

(30) Foreign Application Priority Data
Jan. 26, 2024 (EP) 24154080.6

(51) Int. Cl. B60J 7/043; B60J 7/057; B60J 7/185

(52) U.S. Cl. CPC B60J 7/0435; B60J 7/0573; B60J 7/1855; B60J 7/1856

(57) ABSTRACT

A roof system for a vehicle includes two guide rails extending in a longitudinal direction of said vehicle at lateral sides of a roof opening. A panel is movable between a closed position, a tilted position, and a fully opened position. A first locking mechanism maintains the panel in its closed position, while a second locking mechanism locks a tilting mechanism. A first locking mechanism is located at a guide rail section located completely ahead of and remote from a front mechanism or located completely rearward of and remote of the tilting mechanism, and is operatively connected to the front mechanism by a first link. Optionally, the second locking mechanism is located at a guide rail section located completely ahead of and remote from the front mechanism or located completely rearward of and remote of the tilting mechanism, and is connected to the tilting mechanism by a second link.

### CROSS-REFERENCE TO RELATED APPLICATION

The present application is based on and claims the benefit of European patent application Serial No. 24154080.6, filed Jan. 26, 2024, the content of which is hereby incorporated by reference in its entirety.

### BACKGROUND

The discussion below is merely provided for general background information and is not intended to be used as an aid in determining the scope of the claimed subject matter.

In a known roof system of such a type the first locking mechanism is located at the front mechanism, whereas, likewise, the second locking mechanism is located at the tilting mechanism. It is noted, that according to the state of the art, the front mechanism and first locking mechanism (as well as the tilting mechanism and the second locking mechanism) not only are located at the same position, but also may be combined or integrated into a single mechanism (for example involving a number of specially designed cooperating curved tracks, cams, levers etcetera, as is known per se).

A disadvantage of such a design is that the overall constructional height at the front mechanism as well as at the tilting mechanism is rather large, which results in the need for a large headroom package.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

In a roof system for a vehicle with two guide rails extending in a longitudinal direction of said vehicle at lateral sides of a roof opening, a panel is movable between a closed position, a tilted position, and a fully opened position. A first locking mechanism maintains the panel in its closed position, while a second locking mechanism locks a tilting mechanism. The front mechanism and the first locking mechanism as well as the tilting mechanism and the second locking mechanism are separate mechanisms, wherein the first locking mechanism is located at a guide rail section located completely ahead of and remote from a front mechanism or located completely rearward of and remote of the tilting mechanism, and is operatively connected to the front mechanism by a first link. Optionally, the second locking mechanism is located at a guide rail section located completely ahead of and remote from the front mechanism or located completely rearward of and remote of the tilting mechanism, and is connected to the tilting mechanism by a second link.

The front mechanism and the first locking mechanism (and optionally the tilting mechanism and the second locking mechanism) are taken apart (separated) in such a manner that the first locking mechanism is located at a guide rail section located completely ahead of and remote from the front mechanism or located completely rearward of and remote of the tilting mechanism (and optionally such that likewise the second locking mechanism is located at a guide rail section located completely ahead of and remote from the front mechanism or located completely rearward of and remote of the tilting mechanism). This allows to reduce the constructional height (which otherwise among others would be defined by the locking mechanisms) at the front mechanism (and optionally at the tilting mechanism).

For safeguarding the proper operation of the roof system, especially the locking of the front mechanism and thus the panel (and optionally the locking of the tilting mechanism), the first locking mechanism is operatively connected to the front mechanism by a first link (and optionally the second locking mechanism is operatively connected to the tilting mechanism by a second link).

The operating part for the front mechanism controls the operation of the front mechanism regarding lifting the forward edge of the panel and thereafter moving the panel in a rearward direction, whereas the first link, when locked (at its end engaging the first locking mechanism and remote from the front mechanism) by means of the first locking mechanism, keeps the front mechanism (and thus the panel) at a fixed longitudinal position with respect to the vehicle (without, however, obstructing a movement of the front mechanism for only lifting the forward end of the panel without moving the panel in the rearward direction) until an unlocking is needed for allowing the panel to shift to the rear.

It is noted that the first link generally will be connected directly to the front mechanism, but it also is conceivable that the first link is indirectly connected to the front mechanism through the panel (because such a front mechanism is connected to the panel).

In one preferred embodiment it is conceivable that the first link also defines the operating part for the front mechanism, and thus is responsible too for lifting the forward edge of the panel and shifting the panel rearward.

The second link is responsible for locking the tilting mechanism (in the tilt position of the panel). However, in one embodiment the second link also defines the operating part for the tilting mechanism. As a result, then, the second link will also control (or cause the movement of) the tilting mechanism for lifting the rear end of the panel to the tilt position in addition to locking the tilting mechanism in a position in which said rear end is in the lifted, tilt position (after which the entire tilting mechanism basically remains stationary while the panel, as driven by the front mechanism, slides to the rear relative to the tilting mechanism). The locking of the second link is caused at the second locking mechanism where the respective end of the second link will be locked.

Although it is conceivable that the first and second locking mechanism are located at different positions (for example one ahead of the front mechanism and one rearward of the linking mechanism), preferably the first locking mechanism and the second locking mechanism are located at the same guide rail section. As will appear below, this guide rail section may have different locations and orientations.

In one embodiment, said guide rail section is a prolongation of the guide rail. As such, the guide rail section may be an integral part of the guide rail, or may be a separate section that (by any appropriate means) is joined to the guide rail.

Alternatively, said guide rail section and the guide rail are separate parts with a gap therebetween. Such a gap, for example, may be useful in accommodating parts of the vehicle or the roof system and makes the application of the roof system more versatile, as well as its mounting and dismounting simpler.

Depending, among others, from the geometry of the roof of the vehicle, the guide rail section and the guide rail may extend in line with each other or may extend at an angle with respect to each other, said angle being different from 0 or 180 degrees. As such it is possible, for example, to offer the guide rail section an orientation which copes with a specific shape of the vehicle roof, for example when the vehicle roof tapers in a rearward direction, or to position the guide rail section (and thus the locking mechanism) in an optimal manner with respect to a number of different requirements.

Preferably said guide rail section, as seen in a top plan view, is located outside the boundaries of the roof opening, such as, in an embodiment, rearward of the roof opening (for example below a fixed panel extending rearward of the roof opening). Generally, at such a location more space for accommodating the locking mechanisms will be available, whereas the unobstructed dimensions of the roof opening will be optimized.

However, under certain circumstances it also may be conceivable that said guide rail section, as seen in a top plan view, is located inside the boundaries of the roof opening and preferably near to the forward or rearward edge of the roof opening. In such a case the orientation of the guide rail section and the respective locking mechanism then may be chosen, for example, to be (substantially) in the widthwise direction of the vehicle such as to occupy as little space as possible in the lengthwise direction for optimizing the unobstructed dimension of the roof opening.

The at least one operating part is responsible for in a specific timed manner causing the operation of the front mechanism, first locking mechanism, tilting mechanism and second locking mechanism such that the panel, starting from its closed position, firstly moves to the tilted position, next to a position with also its forward end lifted and finally to its fully opened position (in this aspect, the phrase ‘in a specific timed manner’ intends to express that the operating part determines the specific moments in time, and relations therebetween, at which the mentioned mechanisms move in a respective desired manner and thus determines a specific order of kinematic movement of these mechanisms). Although each of these mechanisms may have its own operating part (which then should be properly synchronized), in one embodiment at least two of the front mechanism, first locking mechanism, tilting mechanism and second locking mechanism share a common operating part, resulting in an automatic synchronization of the movements of such mechanisms (as is required for the correct functioning-opening and closing-of the panel). Such a combined operating part may comprise a control member which is slidable in the guide rail section, and which is driven by a drive member, such as a push-pull cable. Such a control member may comprise curved tracks and other components for the timed control of the mechanisms, as is known per se.

It should be noted that, although a drive member, operating parts and links are mentioned here, a distinction between such parts may not always be very clear because functions of such parts may overlap, and such a drive member or link then also may be seen as a part of the operating member.

The operating part may be one of a group at least comprising a spindle motor, a linear motor and a drive cable driven by an electric motor.

The front mechanism and/or the first locking mechanism and/or the tilting mechanism and/or the second locking mechanism comprise(s) cooperating curved tracks and cams, but also other components such as levers, springs etcetera, as is well known from the state of the art. The precise manner in which these mechanisms operate can vary.

The first link and/or the second link may comprise(s) one of a group at least comprising a push/pull cable and a rod.

When the operating part is a push/pull cable, it may enter the guide rail at the gap between the guide rail section and the remainder of the guide rail (when these guide rail parts indeed are separate parts), which allows to choose an alternative or optimal routing of such a drive member, especially when the drive motor is located at the front.

The roof system offers a number of advantages, of which the following may be mentioned (without the intention to give a limitative list of advantages):
the new position of the locking mechanism for the front mechanism (or for the tilting mechanism), for example underneath a rear panel (behind the roof opening), creates additional space at the front mechanism (or at tilting mechanism) to save more package and offers more headroom for occupants of the vehicle;
interference between glass screws and the front mechanism/tilting mechanism is limited or even eliminated;
by making the front mechanism/tilting mechanism less complex, the package can be reduced, but also strength, stability, and robustness can be improved;
by moving the first and second locking mechanisms (for example to the rear underneath a rear panel), both locking mechanisms can be positioned in an area where package for the locking mechanism is less critical, which means that there is more space available to improve robustness of the locking mechanisms and to improve (reduce) locking noises on system level;
moving the locking mechanisms (such as to the rear underneath a rear panel) means that they will be more isolated against producing noises for the driver, and they are protected against misuse since they are not visible/reachable anymore. Also, dust/pollutions cannot enter the locking mechanisms anymore which is better for lifetime endurance and for avoiding risks of malfunctions;
the guide rail in the open position of the panel will appear much cleaner visually;
also, other parts of the roof system will look cleaner, which means that less covers (inner and outer covers) are needed, which can save package;
the drive member (e.g. a drive cable) does not have to go underneath a wind deflector positioned ahead of the roof opening, which would lead to going into the guide with a bend from underneath, creating complex shapes and machining of the guide. It decreases complexity of the guide and other roof system parts (such as a frame) in the front area;
the front mechanism (and possibly the tilting mechanism) will get shorter in the longitudinal direction, which improves the slide opening in case of smaller panels;
a (rear or forward) locking-driving module can be created which has a driven part. This creates options for operating the driven part with several alternatives, like traditional drive cables with motor, spindle motor, linear motors, etc. . . . ;
such a locking-driving module can be positioned anywhere in the roof area, also for example perpendicular in cross members of the vehicle roof.

### BRIEF DESCRIPTION OF THE DRAWINGS

Hereinafter aspects of the invention will be elucidated while referring to the drawings, in which:

FIGS. 1 and 2 are schematic perspective views of a vehicle roof with a roof system with a panel in a closed (tilted) and open position, respectively;

FIGS. 3 and 4 in schematic top plan and elevational side views, respectively, illustrate a state-of-the-art roof system;

FIG. 5 is a schematic side elevational view of an embodiment of a roof;

FIGS. 6a-6d in schematic top plan views illustrate different embodiments of the roof system; and

FIG. 7 is an exploded view of an example of locking mechanisms for the roof system of FIG. 5.

### DETAILED DESCRIPTION OF ILLUSTRATIVE EMBODIMENTS

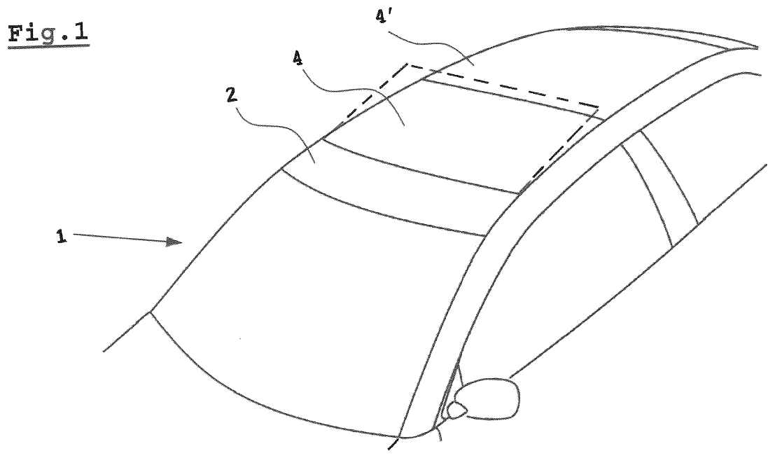

Firstly, referring to FIGS. 1 and 2, a roof system for a vehicle 1 is schematically illustrated in a perspective view and in two different positions. In a fixed roof 2 of the vehicle 1 a roof opening 3 is defined which can be closed (FIG. 1) and opened (FIG. 2) by a movable closure, here a rigid, at least partly (semi) transparent first panel 4, made of glass, plastic material, or the like. The roof system further may include a second panel 4′ which is generally a fixed panel, but which may be movable as well.

The roof system is a so-called top-loaded roof system in which a stationary part or frame of the roof system is introduced onto and around the roof opening 3 from above, to be rested on a respective part of the fixed roof, normally a flange of a roof beam (as is generally known). The stationary part of the roof system then is attached to the fixed roof 2 of the vehicle 1 in a suitable manner, preferably by gluing, but also welding and bolting would be possible, depending on the materials used.

The roof system shown here is a so-called spoiler roof in which panel 4 from its closed position is movable upwardly (at least with its rear end) and then rearwardly to positions above the fixed roof 2, or in this case above rear panel 4′. The operating mechanism for causing such movements, in particular supports for the panel 4, remains mainly within the roof opening 3, contrary to a top slider roof in which rear supports of the panel 4 slide in guide rails that extend or are extended to positions behind the roof opening 3.

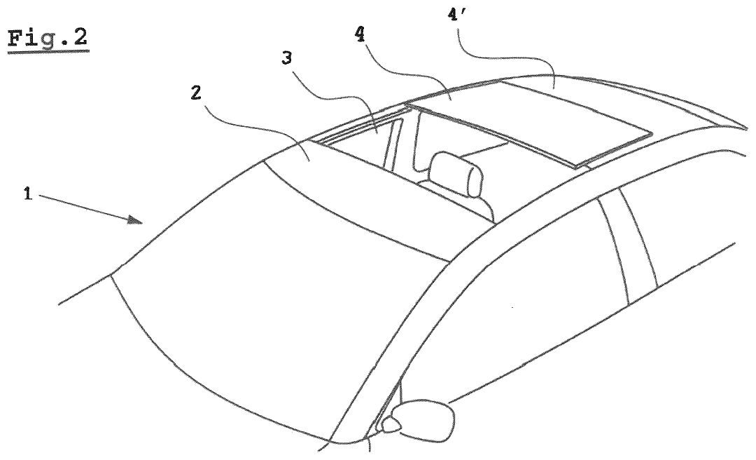

In FIGS. 3-6 the left side always corresponds with the forward end of the vehicle.

Referring to FIGS. 3 and 4, the basic elements of such a roof system and their functional relations will be explained with relation to a known roof system of the type to which the invention relates. FIG. 3 is a schematic top plan view, and FIG. 4 is a schematic side elevational view showing only elements at one lateral side, and one should understand that similar (mostly mirror-shaped) elements generally will be provided at the other lateral side.

The roof system, apart from the roof opening 3 in the fixed roof 2 of the vehicle 1, firstly comprises two guide rails 5 extending in a longitudinal direction of said vehicle at opposite lateral sides of the roof opening 3 and a panel 4 which is movable relative to the guide rails 5 between a closed position (see solid lines in FIG. 1) in which the roof opening 3 is closed, a tilted position (see dotted lines in FIG. 1) in which a rear end of the panel 4 is lifted and a fully opened position (see FIG. 2) in which also the forward end of the panel 3 is lifted and the panel is shifted to the rear over the fixed roof (or over the fixed panel 4′).

The roof system further is provided with front mechanisms F cooperating with each of the guide rails 5 and the panel 4 for lifting the forward end of the panel and for shifting the panel to the rear, as well as first locking mechanisms L1 cooperating with each of the guide rails 5 and the front mechanism F for maintaining the panel in its closed position (it should be noted that the closed position also can be a position in which the forward end of the panel 4 already has been lifted to some extent but in which the panel has not yet been shifted to the rear). Although a first locking mechanism L1 is shown for each guide rail 5, it also is possible to use a single first locking mechanism at one of the guide rails 5 only.

The front mechanism F and cooperating first locking mechanism L1 both are positioned near the forward end of the panel 4 and the movement and function of these mechanisms is controlled by the movement of an operating part 6, in this case a push/pull cable that can slide in the guide rail 5 and which is driven by, for example, an electric motor (not shown). This is known from the state of the art and will not be explained in further detail here.

The roof system further is provided with tilting mechanisms T cooperating with each of the guide rails 5 and the panel 4 for moving (lifting) the panel (with its rearward end) to the tilted position, as well as second locking mechanisms L2 cooperating with each of the guide rails 5 and the tilting mechanisms for maintaining the tilting mechanisms in a position in which the rear end of the panel is lifted to the tilted position (in which locked position the panel 4 next can shift, as driven by the front mechanisms F, to the rear relative to the tilting mechanisms which then remain substantially stationary). Although a second locking mechanism L2 is shown for each guide rail 5, it also is possible to use a single second locking mechanism at one of the guide rails 5 only.

The tilting mechanism T and cooperating second locking mechanism L2 both are positioned near the rear end of the panel 4 and the movement and function of these mechanisms is controlled by the movement of the same operating part 6. This also is well-known known from the state of the art and will not be explained in further detail here.

The operating part 6 is responsible for in a specific timed manner causing the operation of the front mechanism, first locking mechanism, tilting mechanism and second locking mechanism, such that the panel 4, starting from its closed position, for example firstly moves to the tilted position, next to a position with also its forward end lifted and finally to its fully opened position, during which sequence the first and second locking mechanisms L1 and L2 lock and unlock at appropriate times. Other sequences are conceivable too, however.

Although in FIGS. 3 and 4 the mechanisms F, L1, T and L2 are represented as separate units, it also is conceivable that mechanisms F and L1 are combined into a single unit, as applies too for mechanisms T and L2.

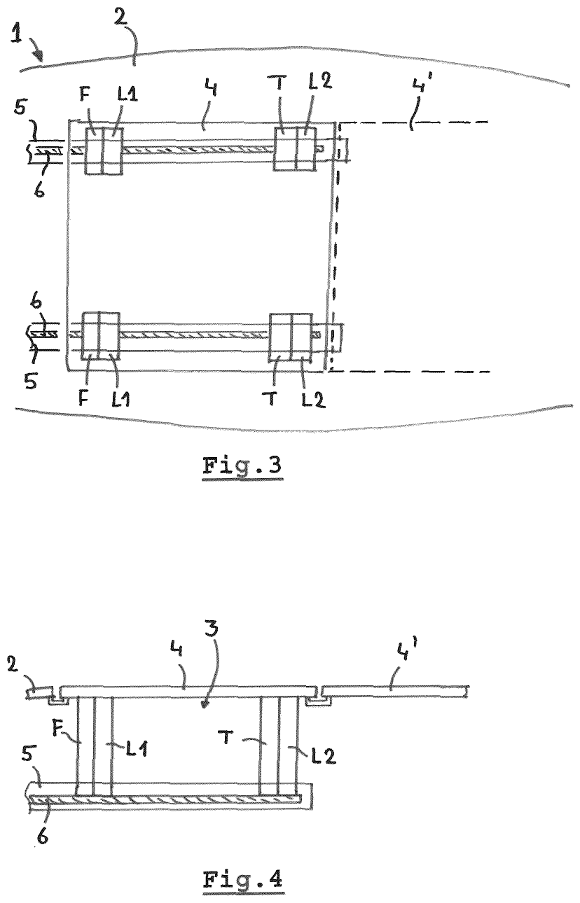

Now referring to FIG. 5, a schematic side elevational view (according to the view in FIG. 4) is shown of an embodiment of a roof system.

The front mechanism F and the first locking mechanism L1 now are separate mechanisms (as regarding their respective locations). The front mechanism F obviously has the same position as in FIG. 4, but the first locking mechanism L1 now is located at a guide rail section 5′ located completely rearward of and remote of the tilting mechanism T, specifically underneath the fixed panel 4′ and rearward of the roof opening 3. The guide rail section 5′ is separated from the guide rail 5 (but in an alternative embodiment also may be connected thereto).

The first locking mechanism L1 is operatively connected to the front mechanism F by a first link 7 which preferably extends through the guide rail section 5′ and through the guide rail 5.

In this embodiment the first link 7 also will act as the operating part for the front mechanism F, such that at the front mechanism the original operating part 6 can be dispensed with or may not be connected to the front mechanism F.

In an alternative embodiment (not shown) the operating member 6 still connects to the forward mechanism F for causing the desired movement thereof (and of the panel 4), whereas the first link 7, when locked at its end connected to the first locking mechanism L1, is able to lock the front mechanism F (and thus indirectly the panel 4) against a movement.

The timed operation of the first locking mechanism L1 (also in relation to the operation of the front mechanism F) between locking and unlocking is caused directly by the operating part 6 (or through a control member C operated by the operating part 6).

Because the first locking mechanism L1 is no longer positioned at (or is no longer integrated into) the forward mechanism F, the resulting mechanism at such location can be constructed with a reduced height (it is noted that due to the schematic nature of the enclosed figures such a reduced height is not illustrated).

Further, the tilting mechanism T (which has the same position as in FIG. 4) and the second locking mechanism L2 likewise are separate mechanisms (regarding their respective locations), and the second locking mechanism also is located at said guide rail section 5′. The timed operation of the second locking mechanism L2 (also in relation to the operation of the tilting mechanism) between locking and unlocking also is caused by the operating part 6 (directly or through the control member C operated by the operating part 6).

The second locking mechanism L2 is operatively connected to the panel by a second link 9 which preferably extends through the guide rail section 5′ and through the guide rail 5 and which is connected to the tilting mechanism T.

In the illustrated embodiment the second link 9 also defines (or takes over the function of) the operating part 6 vis-à-vis the tilting mechanism T.

In an alternative embodiment the operating part 6 may still be responsible for driving the tilting mechanism T while the second link 9 (as controlled at its respective end by the second locking mechanism L2) is responsible for the locking and unlocking of the tilting mechanism T.

Because the second locking mechanism L2 is no longer positioned at (or is no longer integrated into) the tilting mechanism T, the resulting mechanism at such location can be constructed with a reduced height.

In the illustrated embodiment the first and second locking mechanisms L1 and L2 are positioned adjacent each other, and it is conceivable that they are combined into a single unit offering both locking functions. They also can be combined with the control member C, if provided).

The guide rail section 5′ not necessarily has to be separated from the guide rail 5 as illustrated in FIG. 5, but also may be an (integral or joined) prolongation of the guide rail 5. However, when these guide rail parts are separated by a gap, the operating part 6 (or a branch thereof) may be routed through said gap (see operating part 6′ in FIG. 5) to a desired location, for example to a driving source such as an electric motor. This also can prevent a complicated tortuous route (see route P in FIG. 5) of the operating part at the forward end of the roof opening 3 underneath a wind deflector 10 (indicated in part and schematically in broken lines in a stored position) ahead of the roof opening 3.

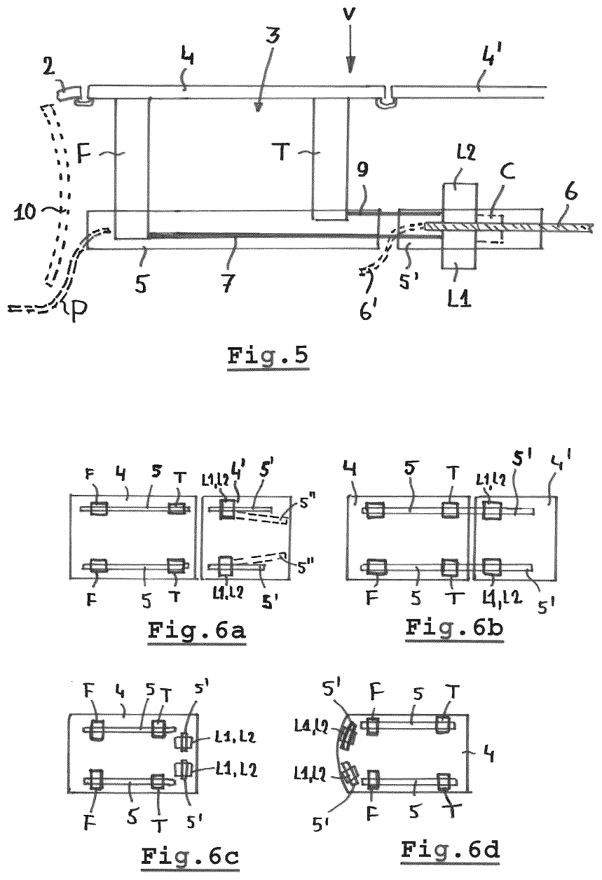

Most generally, the guide rail section 5′ and the guide rail 5 will extend in line with each other. However, it is conceivable too that (especially when seen in a top plan view according to direction V in FIG. 5) the guide rail section 5′ and the guide rail 5 extend at an angle with respect to each other, said angle being different from 0 or 180 degrees (see below FIGS. 6a, 6c and 6d).

Features of a number of different embodiments of the roof system are illustrated in FIG. 6 (showing a number of extremely schematical top plan views).

In FIG. 6a an embodiment according to FIG. 5 is illustrated, in which the guide rail 5 and guide rail section 5′ extend in line of each other and are physically separated. In broken lines an alternative, inwardly inclined orientation of the guide rail sections 5″ is shown, for example for coping with a narrowing shape of the roof in a rearward direction. In FIG. 6b a similar configuration in line with each other is shown, however here guide rail 5 and guide rail section 5′ are joined (or define a single, integral, guide rail).

The guide rail sections 5′ in each case are located outside the boundaries of the roof opening 3 (which substantially coincides with the outline of panel 4) and rearward of the roof opening, as well as below the fixed panel 4′ (or fixed roof 2 when such a fixed panel 4′ is missing). A position ahead of the roof opening 3 (below the fixed roof 2) is possible as well.

FIG. 6c illustrates an embodiment in which the guide rail sections 5′, as seen in a top plan view, are located inside the boundaries of the roof opening and near to the rearward edge of the roof opening. Furthermore, these guide rail sections 5′ include an angle (in this case of about 90 degrees) with the guide rails 5. Of course, a position near to the forward edge of the roof opening is conceivable as well, see FIG. 6d. The angle included here differs from 90 degrees because the guide rail sections 5′ substantially follow a curved frontal contour of the panel 4 (and roof opening). These two embodiments in particular are suited for a situation in which the fixed panel 4′ is absent.

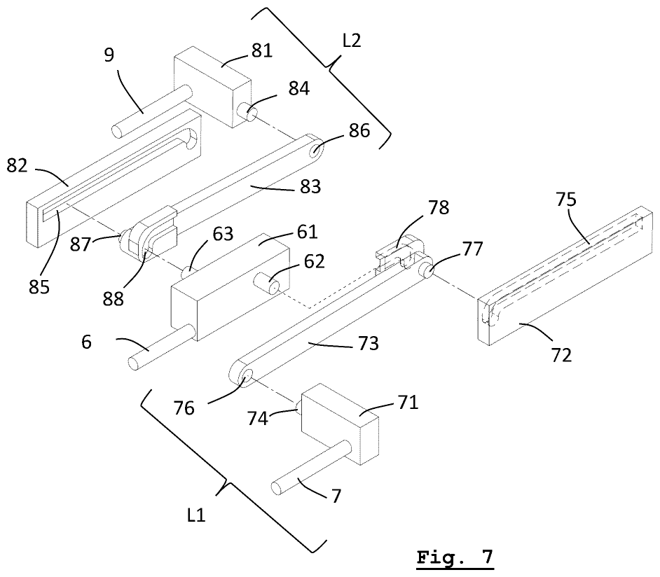

Referring to FIG. 7, examples of the first locking and second locking mechanisms L1, L2 are illustrated in more detail. A locking joint 61 is operated by the operating part 6. The locking joint 61 locks and unlocks the first and second locking mechanisms L1 and L2, respectively, via first and second locking cams 62, 63.

The first locking mechanism L1 includes a first hinge block 71, a first locator 72, and a first locking lever 73. The first hinge block 71 operates the first link 7 and includes a locking pin 74 cooperating with a pivot hole 76 of the locking lever 73. The first locator 74 includes a first locator curve 75 cooperating with a first locator cam 77 of the first locking lever 73. The locking lever 73 further includes a first locking joint 78 with a locking curve for cooperating with the first locking cam 62 of the locking joint 61.

The second locking mechanism L2 includes a second hinge block 81, a second locator 82, and a second locking lever 83. The second hinge block 81 operates the second link 9 and includes a locking pin 84 cooperating with a pivot hole 86 of the locking lever 83. The second locator 84 includes a second locator curve 85 cooperating with a second locator cam 87 of the second locking lever 83. The locking lever 83 further includes a second locking joint 88 with a locking curve for cooperating with the second locking cam 63 of the locking joint 61.

In this example, the operating part 6 runs forward in the guide rail to be operated by e.g. a motor or a driven slide. In other examples, the operating part 6 may run rearward to be operated. As may be understood, various cooperating members, such as cams and curves, may be interchanged to obtain mechanically inverse configurations, while maintaining the same functional operations. Also the connection of the first link 7 and the second link 9 may be interchanged, converting what is described as elements of the first locking mechanism L1 into elements of the second locking mechanism L2. And vice versa.

In the roof system described above a large number of members will be provided which are required for obtaining the desired (relative) movements of the constitutive parts of the roof system, such as, for example, cooperating curved tracks, cams, and levers, as will be apparent for persons skilled in the art. For understanding the present invention, a detailed description of such members, however, is not required.

The invention is not limited to the embodiments described which may be varied widely within the scope of the invention as defined by the appending claims.

Although the present invention has been described with reference to preferred embodiments, workers skilled in the art will recognize that changes may be made in form and detail without departing from the spirit and scope of the invention.

What is claimed is:

1. A roof system for a vehicle having a roof opening in a fixed roof, comprising:
two guide rails configured to extend in a longitudinal direction of said vehicle at opposite lateral sides of the roof opening;
a panel configured to move relative to the guide rails between a closed position in which the roof opening is closed, a tilted position in which a rear end of the panel is lifted and a fully opened position in which a forward end of the panel is lifted and the panel is shifted rearward over the fixed roof;
a front mechanism configured to cooperate with the guide rails and the panel to lift the forward end of the panel and to shift the panel rearward;
a first locking mechanism configured to cooperate with the guide rails and the front mechanism to maintain the panel in the closed position;
a tilting mechanism configured to cooperate with the guide rails and the panel to move the panel to the tilted position;
a second locking mechanism configured to cooperate with the guide rails and the tilting mechanism to maintain the tilting mechanism in a position in which the rear end of the panel is lifted to the tilted position;
at least one operating part which is configured to move in one of the guide rails and which is responsible for in a specific timed manner causing the operation of the front mechanism, first locking mechanism, tilting mechanism and second locking mechanism such that the panel, starting from the closed position, firstly moves to the tilted position, next to a position with also the forward end lifted and finally to the fully opened position, wherein the front mechanism and the first locking mechanism are separate mechanisms, wherein the first locking mechanism is at a guide rail section located completely ahead of and remote from the front mechanism or located completely rearward of and remote of the tilting mechanism; and
a first link operatively connecting the first locking mechanism to the front mechanism.

2. The roof system according to claim 1, wherein the tilting mechanism and the second locking mechanism are separate mechanisms, wherein the second locking mechanism is located at a guide rail section located completely ahead of and remote from the front mechanism or located completely rearward of and remote of the tilting mechanism, and wherein the second locking mechanism is operatively connected to the tilting mechanism by a second link.

3. The roof system according to claim 2, wherein the first link also defines the operating part for the front mechanism and/or wherein the second link also defines the operating part for the tilting mechanism, respectively.

4. The roof system according to claim 1, wherein the first locking mechanism and the second locking mechanism are located at a same guide rail section.

5. The roof system according to claim 1, wherein said guide rail section is a prolongation of the guide rail.

6. The roof system according to claim 1, wherein said guide rail section and the guide rail are separate parts with a gap therebetween.

7. The roof system according to claim 6, having a drive motor in front of the roof opening, wherein the operating part is a push/pull cable and enters the guide rail at the gap between the guide rail section and the guide rail.

8. The roof system according to claim 1, wherein the guide rail section and the guide rail extend in line with each other.

9. The roof system according to claims 1, wherein the guide rail section and the guide rail extend at an angle with respect to each other, said angle being different from 0 or 180 degrees.

10. The roof system according to claim 1, wherein said guide rail section, as seen in a top plan view, is configured for location outside boundaries of the roof opening.

11. The roof system according to claim 10, wherein said guide rail section, as seen in a top plan view, is configured for location rearward of the roof opening.

12. The roof system according to claim 1, wherein said guide rail section, as seen in a top plan view, is configured for location inside boundaries of the roof opening.

13. The roof system according to claim 12, wherein said guide rail section, as seen in a top plan view, is configured for location near to a forward or rearward edge of the roof opening.

14. The roof system according to claim 1, wherein at least two of the front mechanism, first locking mechanism, tilting mechanism and second locking mechanism share a common operating part.

15. The roof system according to claim 1, wherein the operating part is one of a group at least comprising a spindle motor, a linear motor and a drive cable driven by an electric motor.

16. The roof system according to claim 1, wherein the front mechanism and/or the first locking mechanism and/or the tilting mechanism and/or the second locking mechanism comprise(s) cooperating curved tracks and cams.

17. The roof system according to claim 2, wherein the first link and/or the second link comprise(s) one of a group at least comprising a push/pull cable and a rod.

18. The roof system according to claim 2, wherein the first link also defines the operating part for the front mechanism and/or wherein the second link also defines the operating part for the tilting mechanism, respectively.
